(19) United States
(12) Patent Application Publication
(10) Pub. No.: US 2026/0321571 A1
(43) Pub. Date: Oct. 15, 2026

(54) CONTROL METHOD AND SYSTEM FOR BATTERY ELECTRODE ROLL PRESSING PROCESS

(71) Applicant: SK ON CO., LTD., Seoul (KR)

(72) Inventors: Jun Ha CHOI, Daejeon (KR); Wan Tak CHO, Daejeon (KR); Yun Jong KIM, Daejeon (KR); Ji Yun YANG, Daejeon (KR); Hyeong Uk CHOI, Daejeon (KR)

(21) Appl. No.: 19/464,610

(22) Filed: Jan. 30, 2026

(30) Foreign Application Priority Data
Feb. 18, 2025 (KR) 10-2025-0020574

(51) Int. Cl. H01M 4/04

(52) U.S. Cl. CPC H01M 4/0435; H01M 4/0404

(57) ABSTRACT

A control method for a battery electrode roll pressing process, according to an embodiment of the present disclosure, includes obtaining thickness values for an electrode sheet rolled by mill rolls; and controlling a gap between the mill rolls and a side pressure of the mill rolls, based on the thickness values, wherein the controlling uses a first control logic controlling the gap between the mill rolls, based on a first magnitude relationship of the thickness values, with respect to a target thickness value, and uses a second control logic selectively adjusting the side pressure of the mill rolls, according to whether a positive/negative sign of a second magnitude relationship of an one-side region thickness value with respect to a central region thickness value is equal to a positive/negative sign of a third magnitude relationship of an other-side region thickness value with respect to the central region thickness value.

### CROSS-REFERENCE TO RELATED APPLICATION(S)

This patent document claims the priority and benefits of Korean Patent Application No. 10-2025-0020574 filed on Feb. 18, 2025, the disclosure of which is incorporated herein by reference in its entirety.

### TECHNICAL FIELD

The disclosure and implementations disclosed in this patent document generally relate to a control method and system for a battery electrode roll pressing process.

### BACKGROUND

Batteries may be widely used not only in small electronic devices such as mobile phones and laptops, but also in medium and large-sized mechanical devices such as electric vehicles (EVs), and may have advantages of being able to be charged and reused.

A roll pressing process of battery manufacturing processes may flat-roll an electrode sheet to increase an energy density of a battery electrode manufactured from the electrode sheet, and increase energy efficiency of a battery.

### SUMMARY

A control method and system for a battery electrode roll pressing process, according to an embodiment of the present disclosure, may control an overall thickness and a thickness deviation of an electrode sheet rolled according to a roll pressing process, and may be advantageous in establishing automated thickness control of the electrode sheet.

A control method for a battery electrode roll pressing process, according to an embodiment of the present disclosure, includes obtaining a central region thickness value, a one-side region thickness value, and an other-side region thickness value for an electrode sheet rolled by a plurality of mill rolls; and controlling a gap between the plurality of mill rolls and a side pressure of the plurality of mill rolls, based on the central region thickness value, the one-side region thickness value, and the other-side region thickness value, wherein the controlling uses a first control logic controlling the gap between the plurality of mill rolls, based on a first magnitude relationship of at least one of the central region thickness value, the one-side region thickness value, or the other-side region thickness value, with respect to a target thickness value, and uses a second control logic selectively adjusting the side pressure of the plurality of mill rolls, according to whether a positive/negative sign of a second magnitude relationship of the one-side region thickness value with respect to the central region thickness value is equal to a positive/negative sign of a third magnitude relationship of the other-side region thickness value with respect to the central region thickness value.

For example, the second control logic may include adjusting the side pressure of the plurality of mill rolls, when the positive/negative sign of the second magnitude relationship is equal to the positive/negative sign of the third magnitude relationship, and maintaining the side pressure of the plurality of mill rolls, when the positive/negative sign of the second magnitude relationship is different from the positive/negative sign of the third magnitude relationship, a slope type.

For example, the second control logic may include maintaining the side pressure of the plurality of mill rolls, when at least one of the second magnitude relationship or the third magnitude relationship falls within an error range including a zero point, a flat type.

For example, the second control logic may include controlling the gap between the plurality of mill rolls to reduce a change in the gap between the plurality of mill rolls according to the controlling the side pressure.

For example, the controlling may include generating a first adjustment value based on a thickness difference between at least one of the central region thickness value, the one-side region thickness value, or the other-side region thickness value, and a target thickness value, and a second adjustment value reducing the change in the gap between the plurality of mill rolls according to the adjustment of the side pressure, and adjusting the gap between the plurality of mill rolls, based on a summed adjustment value of the first and second adjustment values.

For example, the first control logic may include selecting, according to whether a thickness difference between at least one of the central region thickness value, the one-side region thickness value, or the other-side region thickness value, and a target thickness value falls within a plurality of sections, one of a plurality of adjustment values corresponding to each of the plurality of sections, and adjusting the gap between the plurality of mill rolls by a first adjustment value selected from the plurality of adjustment values.

For example, the first magnitude relationship may be a magnitude relationship with respect to the target thickness value, of an averaged value of at least two of the central region thickness value, the one-side region thickness value, or the other-side region thickness value.

For example, the plurality of mill rolls may be configured to roll the electrode sheet, as the electrode sheet passes between the plurality of mill rolls, and a direction in which one-side region and the other-side region of the electrode sheet face each other is perpendicular to a passage direction in which the electrode sheet passes between the plurality of mill rolls.

For example, the controlling may include adjusting pressures of hydraulic cylinders on one side and the other side of the plurality of mill rolls, to adjust the side pressure.

A system for a battery electrode roll pressing process, according to an embodiment of the present disclosure, includes a plurality of mill rolls rolling an electrode sheet; a thickness measuring instrument measuring a central region thickness value, a one-side region thickness value, and an other-side region thickness value for an electrode sheet; and a controller controlling a gap between the plurality of mill rolls and a side pressure of the plurality of mill rolls, based on the central region thickness value, the one-side region thickness value, and the other-side region thickness value, wherein the controller uses a first control logic controlling the gap between the plurality of mill rolls, based on a first magnitude relationship of at least one of the central region thickness value, the one-side region thickness value, or the other-side region thickness value, with respect to a target thickness value, and uses a second control logic selectively adjusting the side pressure of the plurality of mill rolls, according to whether a positive/negative sign of a second magnitude relationship of the one-side region thickness value with respect to the central region thickness value is equal to a positive/negative sign of a third magnitude relationship of the other-side region thickness value with respect to the central region thickness value.

For example, the second control logic may include controlling the gap between the plurality of mill rolls to reduce a change in the gap between the plurality of mill rolls according to the controlling the side pressure.

For example, the controller may generate a first adjustment value based on a thickness difference between at least one of the central region thickness value, the one-side region thickness value, or the other-side region thickness value, and a target thickness value, and a second adjustment value reducing the change in the gap between the plurality of mill rolls according to the adjustment of the side pressure, and may adjust the gap between the plurality of mill rolls, based on a summed adjustment value of the first and second adjustment values.

For example, the first control logic may include selecting, according to whether a thickness difference between at least one of the central region thickness value, the one-side region thickness value, or the other-side region thickness value, and a target thickness value falls within a plurality of sections, one of a plurality of adjustment values corresponding to each of the plurality of sections, and adjusting the gap between the plurality of mill rolls by the first adjustment value selected from the plurality of adjustment values.

For example, the second control logic may include adjusting the side pressure of the plurality of mill rolls, when the positive/negative sign of the second magnitude relationship is equal to the positive/negative sign of the third magnitude relationship, and maintaining the side pressure of the plurality of mill rolls, when the positive/negative sign of the second magnitude relationship is different from the positive/negative sign of the third magnitude relationship, a slope type.

For example, the second control logic may include maintaining the side pressure of the plurality of mill rolls, when at least one of the second magnitude relationship or the third magnitude relationship falls within an error range including a zero point, a flat type.

### BRIEF DESCRIPTION OF DRAWINGS

Certain aspects, features, and advantages of the present disclosure may be illustrated by the following detailed description with reference to the accompanying drawings.

FIG. 1 is a flowchart illustrating a control method for a battery electrode roll pressing process according to an embodiment of the present disclosure.

FIGS. 2 and 3 are diagrams illustrating systems for a battery electrode roll pressing process according to an embodiment of the present disclosure.

FIG. 4 is a graph illustrating a thickness value of an electrode sheet of a control method and system for a battery electrode roll pressing process according to an embodiment of the present disclosure.

FIG. 5 is a graph illustrating a change in thickness value of an electrode sheet according to side pressure control of a control method and system for a battery electrode roll pressing process according to an embodiment of the present disclosure.

FIG. 6 is a flowchart illustrating a first control logic for roll gap control of a control method and system for a battery electrode roll pressing process according to an embodiment of the present disclosure.

FIG. 7 is a diagram illustrating a plurality of adjustment values respectively corresponding to the plurality of sections of FIG. 6.

FIG. 8 is a flowchart illustrating a second control logic for roll side pressure control of a control method and system for a battery electrode roll pressing process according to an embodiment of the present disclosure.

FIG. 9 is a flowchart illustrating controlling a gap between a plurality of mill rolls to reduce a difference in gaps between the plurality of mill rolls according to control of a side pressure of a control method and system for a battery electrode roll pressing process according to an embodiment of the present disclosure.

### DETAILED DESCRIPTION

For a detailed description of the present disclosure to be described later, refer to the accompanying drawings illustrating specific embodiments in which the present disclosure is implemented. It should be understood that the various embodiments of the present disclosure are different from each other, but need not be mutually exclusive. For example, specific shapes, structures, and characteristics described herein may be implemented in other embodiments without departing from the spirit and scope of the present disclosure in relation to an embodiment. In addition, it should be understood that the positions or arrangements of individual components in each disclosed embodiment may be changed without departing from the spirit and scope of the present disclosure. Therefore, the detailed description described later may be not intended to be taken in a limited sense, and the scope of the present disclosure, if properly described, may be limited only by the appended claims along with the full scope equivalent to that claimed by the claims. Similar reference numerals in drawings refer to the same or similar functions in many aspects.

Hereinafter, embodiments of the present disclosure will be described in detail with reference to the accompanying drawings in order to easily implement the present disclosure by those skilled in the art.

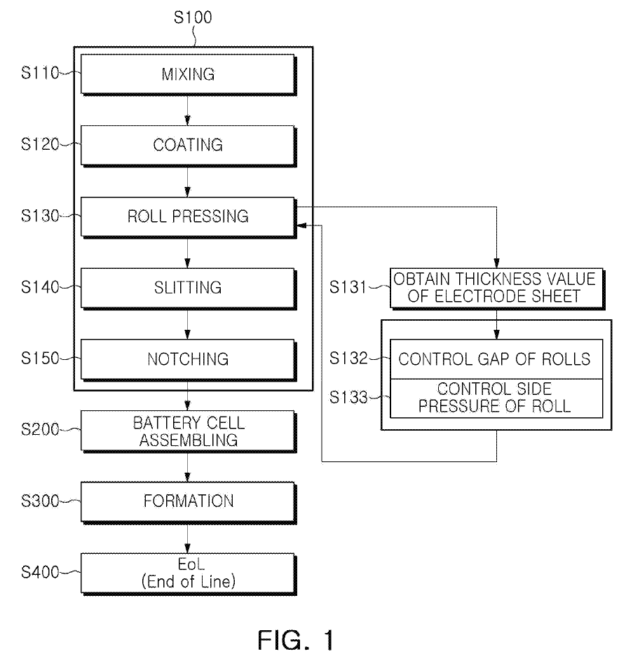

Referring to FIG. 1, battery processes to be sequentially performed may include an electrode manufacturing process (S100), a battery cell assembling process (S200), a conversion process (S300), and an EoL process (S400). End of Line (EoL) may be a post-battery process.

The electrode manufacturing process (S100) may include manufacturing battery electrodes of a battery cell. For example, the electrode manufacturing process (S100) may include a mixing process (S110) of mixing an active material, a conductive agent, a binder, and a solvent, to form slurry, may include a coating process (S120) of coating the slurry on both surfaces of a positive electrode plate (e.g., aluminum plate, copper plate), may include a roll pressing process (S130) of rolling a coated and rolled positive electrode plate (electrode sheet), may include a slitting process (S140) of slitting the coated and rolled positive electrode plate (electrode sheet) to form electrodes, and may include a notching process (S150) of vacuum-drying the electrodes and notching the dried electrodes, to manufacture battery electrodes.

The battery cell assembling process (S200) may include coupling a battery case and the battery electrodes and injecting an electrolyte into the battery case, to manufacture a battery cell. For example, the battery cell assembling process (S200) may include assembling battery electrodes of a tab shape and a separator (e.g., at least one of winding, stacking, jelly roll, Z-folding type, or stack-folding) according to a specific method (e.g., winding, stacking, jelly roll, Z-folding type, or stack-folding), welding the battery electrodes of a tab shape to connect positive electrode plates to each other or negative electrode plates to each other, and disposing the battery electrodes in which the welding is applied in a battery case and injecting an electrolyte into the battery case. The battery case may be a pouch-type case including a sealing portion, but may be implemented as a cylindrical case or a prismatic case depending on a design.

The conversion process (S300) may include charging the battery cell such that the battery cell assembled by the battery cell assembling process (S200) has electrical characteristics. In this case, since a solid electrolyte interphase layer may be formed on negative electrode surfaces of the battery electrodes, at least one battery cell may have a microscopic structure capable of effectuating continuously electrochemical reactions depending on voltages of the battery electrodes.

For example, between the conversion process (S300) and the EoL process (S400), a plurality of battery cells may be stacked and assembled into one battery module. For example, a plurality of battery modules may be assembled into one battery pack or one battery rack.

The EoL process (S400) may include inspecting the at least one battery cell having electrical characteristics. For example, the inspecting may include at least one of inspecting electrical performance (e.g., capacity, charge/discharge voltage/current, internal resistance, insulation resistance) of at least one battery cell, inspecting performance of a temperature sensor, inspecting performance of a battery management system (BMS), and inspecting appearance of a battery cell. A battery in which the EoL process (S400) is completed may be shipped for eco-friendly vehicles such as electric vehicles or for energy storage systems.

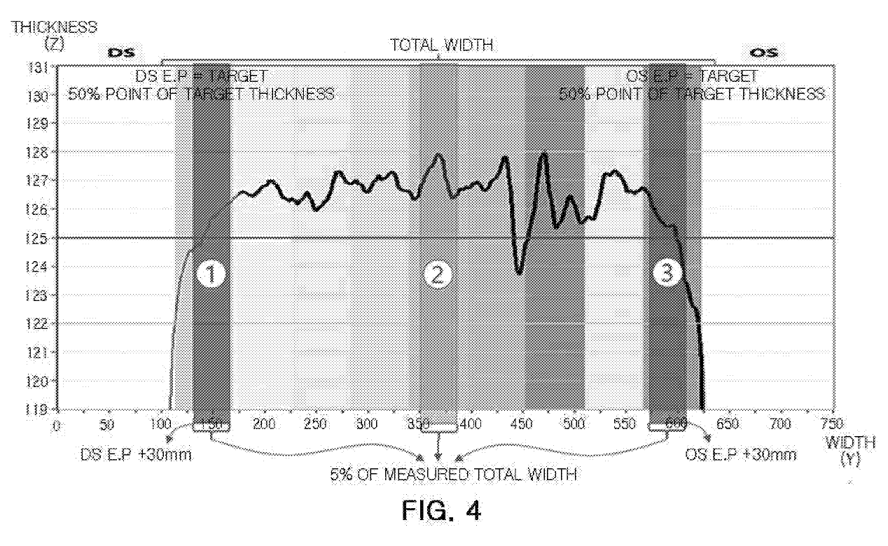

Referring to FIGS. 1, 2 AND 4, a control method for a battery electrode roll pressing process according to an embodiment of the present disclosure may include obtaining a central region thickness value (② of FIG. 4), a one-side region thickness value (① of FIG. 4), and an other-side region thickness value (③ of FIG. 4) for an electrode sheet 10 rolled by a plurality of mill rolls 131 and 132 (S131), and controlling a gap between the plurality of mill rolls 131 and 132 and a side pressure of the plurality of mill rolls 131 and 132, based on the central region thickness value (② of FIG. 4), the one-side region thickness value (① of FIG. 4), and the other-side region thickness value (③ of FIG. 4) (S132 and S133). Accordingly, the control method may include controlling an overall thickness and thickness deviation of the electrode sheet 10 rolled by the roll pressing process (S130).

For example, the first magnitude relationship may be a magnitude relationship of at least two (e.g., (①+③)/2) of the central region thickness value (② of FIG. 4), the one-side region thickness value (① of FIG. 4), or the other-side region thickness value (③ of FIG. 4), with respect to a target thickness value. Compared to one thickness value, an average value of a plurality of thickness values may be a value more accurately reflecting the overall thickness of the electrode sheet 10. Accordingly, overall thickness control of the electrode sheet 10 according to a magnitude relationship of the average value of the plurality of thickness values with respect to the target thickness value may further improve control accuracy.

The controlling (S132 and S133) may use a first control logic (S132) controlling the gap between the plurality of mill rolls 131 and 132, based on a first magnitude relationship of at least one of the central region thickness value (② of FIG. 4), the one-side region thickness value (① of FIG. 4), or the other-side region thickness value (③ of FIG. 4), with respect to a target thickness value. For example, the controlling (S132 and S133) may decrease the gap between the plurality of mill rolls 131 and 132 when the first magnitude relationship is positive, and may increase the gap between the plurality of mill rolls 131 and 132 when the first magnitude relationship is negative.

Accordingly, it may be prevented that the overall thickness of the electrode sheet 10 after a roll pressing device 130 rolls the electrode sheet 10 gradually deviates from a target thickness range, as time elapses. For example, the overall thickness of the electrode sheet 10 may be stably controlled for a long time, need for manual control intervention of an operator may be reduced, and overall thickness control of the electrode sheet 10 may be more stably automated.

The controlling (S132 and S133) may use a second control logic (S133) selectively adjusting the side pressure of the plurality of mill rolls, according to whether a positive/negative sign of a second magnitude relationship of the one-side region thickness value (① of FIG. 4) with respect to the central region thickness value (② of FIG. 4) is equal to a positive/negative sign of a third magnitude relationship of the other-side region thickness value (③ of FIG. 4) with respect to the central region thickness value (② of FIG. 4).

Accordingly, thickness deviation at each point of the electrode sheet 10 may be stably reduced, and quality (e.g., defect prevention) of the battery electrode manufactured from the electrode sheet 10 may be improved. For example, some of battery defect factors may be due to thickness deviation of the battery electrode, but in a control method for a battery electrode roll pressing process according to an example of the present disclosure, since the thickness deviation may be reduced after the electrode sheet 10 is rolled, a battery defect factor due to the thickness deviation of the battery electrode may be removed, and a battery defect rate may be reduced. In addition, need for manual control intervention of an operator for such thickness deviation control may be reduced, and the thickness deviation control of the electrode sheet 10 may be more stably automated.

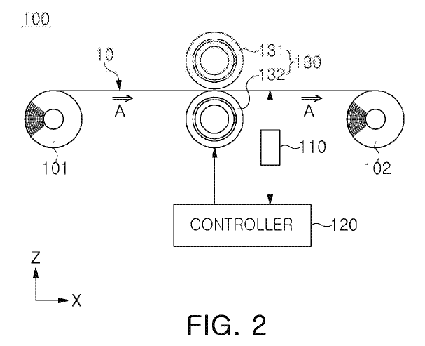

Referring to FIGS. 2 and 4, a system 100 for a battery electrode roll pressing process, according to an embodiment of the present disclosure, may include a plurality of mill rolls 131 and 132, a thickness measuring instrument 110, and a controller 120. The plurality of mill rolls 131 and 132 may roll an electrode sheet 10, and the thickness measuring instrument 110 may measure a central region thickness value (② of FIG. 4), a one-side region thickness value (① of FIG. 4), and an other-side region thickness value (③ of FIG. 4) for the electrode sheet 10.

The thickness measuring instrument 110 may include three or more thickness measuring instruments that measure the central region thickness value (② of FIG. 4), the one-side region thickness value (① of FIG. 4), and the other-side region thickness value (③ of FIG. 4), respectively. For example, each of the three or more thickness measuring instruments may have a measurement range of a specific ratio (e.g., 5%) of a total width of the electrode sheet 10. For example, the controller 120 may adjust the measurement range based on input information (e.g., measurement setting value, electrode sheet setting value) of a user, and may transmit a measurement range adjustment signal to the thickness measuring instrument 110, and the thickness measuring instrument 110 may adjust the measurement range according to the received measurement range adjustment signal.

For example, the thickness measuring instrument 110 and/or the controller 120 may adjust the total measurement range of the thickness measuring instrument 110 slightly wider than a width of the electrode sheet, and may set a limit boundary line close to an outer boundary line of the total measurement range. When a portion of the electrode sheet deviates from the limit boundary line, the thickness measuring instrument 110 and/or the controller 120 may monitor whether the electrode sheet is deviated by checking whether the thickness value between the limit boundary line and the outer boundary line corresponds to the thickness value of the electrode sheet. The thickness measuring instrument 110 and/or the controller 120 may output an alarm (e.g., display output, speaker output, alarm signal transmission to a user terminal, etc.) when it may be determined that the electrode sheet is deviated.

For example, the thickness measuring instrument 110 may measure a thickness of the electrode sheet 10 by measuring a separation distance to the electrode sheet 10 in real time (e.g., measuring the distance by laser, measuring the distance by camera image analysis). For example, the controller 120 may determine that the electrode sheet deviates in an opposite direction when it may be an abnormal thickness value (e.g., 0mm) in at least one of the one-side region thickness value (① of FIG. 4) or the other-side region thickness value (③ of FIG. 4), and may output an alarm when it is determined that the electrode sheet deviates.

For example, the thickness measuring instrument 110 and the controller 120 may communicate with each other, and the thickness measuring instrument 110 may transmit the thickness values measured by the thickness measuring instrument 110 to the controller 120. The controller 120 may obtain the thickness values by receiving the thickness values from the thickness measuring instrument 110 (S131 of FIG. 1).

The controller 120 may control a gap between the plurality of mill rolls 131 and 132 and a side pressure of the plurality of mill rolls 131 and 132, based on the central region thickness value (② of FIG. 4), the one-side region thickness value (① of FIG. 4), and the other-side region thickness value (③ of FIG. 4). Accordingly, the system 100 may control an overall thickness and thickness deviation of the electrode sheet 10 rolled according to the roll pressing process (S130 in FIG. 1).

Since the controller 120 may use the first control logic (S132) of FIG. 1, the overall thickness of the electrode sheet 10 may be stably controlled for a long period of time, need for manual control intervention of an operator may be reduced, and overall thickness control of the electrode sheet 10 may be more stably automated. Since the controller 120 may use the second control logic (S133 of FIG. 1), thickness deviation at each point of the electrode sheet 10 may be stably reduced, and quality (e.g., defect prevention) of a battery electrode manufactured from the electrode sheet 10 may be improved.

For example, the controller 120 may include a computing system (e.g., a microcontroller, a programmable logic controller (PLC), an embedded system, a manufacturing execution system (MES)). For example, the computing system may include a processor (e.g., CPU, GPU), a memory (e.g., volatile memory, nonvolatile memory), a recording medium, an input/output device, or a communication device. For example, the controller 120 may operate in a manner in which a processor executes one or more programs (and/or algorithms and logics) recorded in a memory or a storage, and the operation may correspond to instructions of the program, and may correspond to an operation executed by a control method for a battery electrode roll pressing process according to an embodiment of the present disclosure.

The plurality of mill rolls 131 and 132 may be configured to roll the electrode sheet 10, as the electrode sheet 10 passes between the plurality of mill rolls 131 and 132. For example, an unwinder 101 and a rewinder 102 may be disposed to be spaced apart from each other in -X and +X-directions of the plurality of mill rolls 131 and 132. The

electrode sheet 10 may be wound around the unwinder 101, and the unwinder 101 may supply the electrode sheet 10 in the +X-direction while rotating. In this case, the unwinder 101 and the rewinder 102 may rotate in the same direction in a synchronized state with each other, and the rewinder 102 may wind the electrode sheet 10 rolled by the plurality of mill rolls 131 and 132. Depending on a design, one or more auxiliary rolls for assisting in transfer of the electrode sheet 10 may be provided between the unwinder 101 and the rewinder 102. The plurality of mill rolls 131 and 132 may press upper and lower surfaces of the electrode sheet 10, respectively, and the electrode sheet 10 may have a thinner thickness and a higher density, as the electrode sheet 10 is rolled.

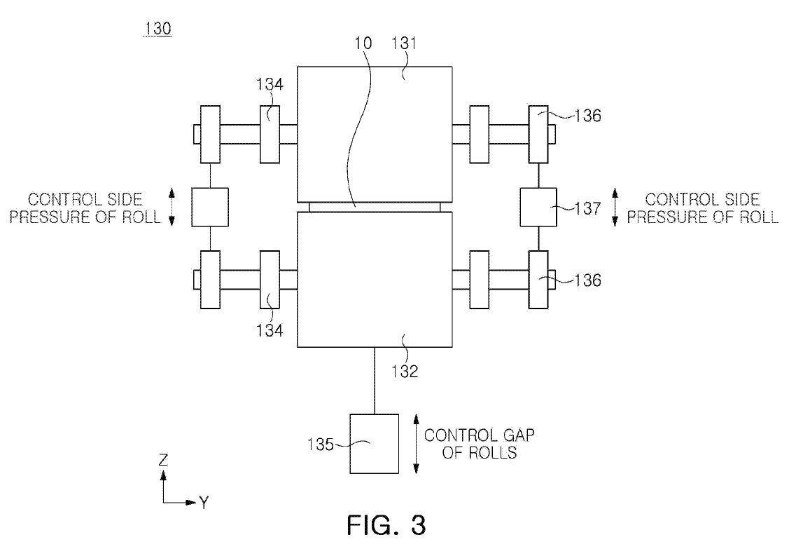

Referring to FIGS. 2 and 3, the roll pressing device 130 may include a rotation shaft 134 coupled to the plurality of mill rolls 131 and 132 and extending in a Y-direction to rotate, a gap adjuster 135 for adjusting a gap between a plurality of mill rolls 131 and 132, a support portion 136 for supporting both ends of the rotation shaft 134, and a hydraulic cylinder 137 for applying pressure (reverse pressure and/or static pressure) to the support portion 136. Depending on a design, the rotation shaft 134 may be integrated with the plurality of mill rolls 131 and 132. For example, the support portion 136 may be implemented as a bearing, and may be connected to the hydraulic cylinder 137 through a rod.

A direction (e.g., Y-direction) in which one-side region (DS of FIG. 4) and an other-side region (OS of FIG. 4) of the electrode sheet 10 face each other may be perpendicular to a passage direction (e.g., X-direction) in which the electrode sheet 10 passes between the plurality of mill rolls 131 and 132, and in the controlling (S132 and S133 of FIG. 1), the controller 120 may adjust pressure (reverse pressure and/or positive pressure) of the hydraulic cylinder 137 on one side and the other side of the plurality of mill rolls 131 and 132.

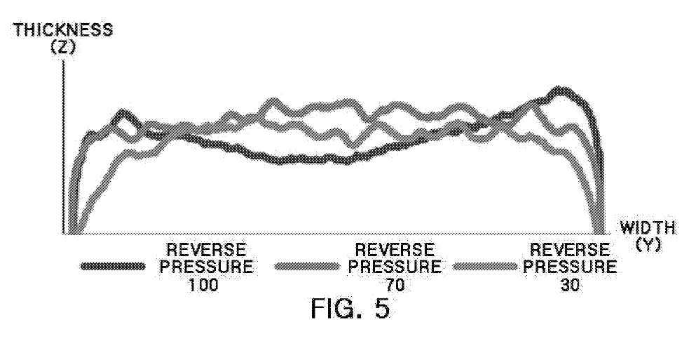

Referring to FIGS. 3 and 5, when the hydraulic cylinder 137 is in a large reverse pressure (e.g., reverse pressure 100) state, side pressures of the plurality of mill rolls 131 and 132 may be reduced, and side thicknesses of the electrode sheet 10 may be relatively greater than central thicknesses. When the hydraulic cylinder 137 is in a small reverse pressure (e.g., reverse pressure 30) state, side pressures of the plurality of mill rolls 131 and 132 may be increased, and side thicknesses of the electrode sheet 10 may be relatively thinner than central thicknesses. When the hydraulic cylinder 137 is in an intermediate reverse pressure (e.g., reverse pressure 70), thicknesses of the plurality of mill rolls 131 and 132 may be further selected.

An optimum reverse pressure of the hydraulic cylinder 137 in FIG. 5 may be a reverse pressure 70, but the optimum reverse pressure may vary from time to time according to other control variables of the roll pressing device 130. The second control logic (S133 in FIG. 1) of the controller 120 may control pressure of the hydraulic cylinder 137 such that a current reverse pressure of the hydraulic cylinder 137 is closer to the optimum reverse pressure, even when the optimum reverse pressure is frequently changed.

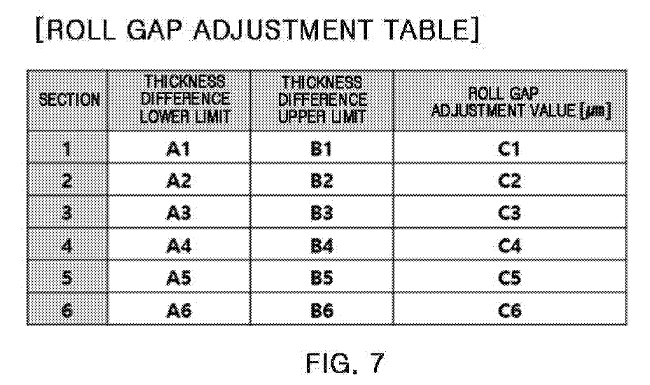

Referring to FIGS. 4, 6 AND 7, the first control logic (S132) may include calculating a thickness difference D between at least one of the central region thickness value (② of FIG. 4), the one-side region thickness value (① of FIG. 4), or the other-side region thickness value (③ of FIG. 4), with respect to the target thickness value (S10), selecting one of a plurality of adjustment values C1, C2, C3, C4, C5, and C6 respectively corresponding to a plurality of sections A1~B1, A2~B2, A3~B3, A4~B4, A5~B5, and A6~B6, according to whether the thickness difference D falls within the plurality of sections A1~B1, A2~B2, A3~B3, A4~B4, A5~B5, and A6~B6 (S20), and adjusting a gap between the plurality of mill rolls by a first adjustment value selected from the plurality of adjustment values C1, C2, C3, C4, C5, and C6 (S20). Accordingly, even when there is no substantial intervention of the operator, the first adjustment value may be automatically and accurately determined. As the number of the plurality of sections increases, the first adjustment value may be determined more precisely.

For example, the memory or storage of the controller (120 of FIG. 2) may store the plurality of sections A1~B1, A2~B2, A3~B3, A4~B4, A5~B5, and A6~B6 and the plurality of adjustment values C1, C2, C3, C4, C5, and C6 in advance (e.g., in the form of a lookup table), and the processor of the controller (120 of FIG. 2) may perform calculation (S10), selection (S20), and adjustment (S30).

For example, in the controller (S132 and S133 in FIG. 1), the controller (120 in FIG. 2), when an absolute value of the thickness difference D falls within the narrowest section A1~B1, may select the smallest adjustment value C1 (S21) and may adjust an increase (D>0) or a decrease (D<0) of the gap between the plurality of mill rolls by the adjustment value C1 (S31), when the absolute value of the thickness difference D falls within a second narrow section A2~B2, may select a second small adjustment value C2 (S22) and may adjust an increase (D>0) or a decrease (D<0) of the gap between the plurality of mill rolls by the adjustment value C2 (S32), when the absolute value of the thickness difference D falls within a third narrow section A3~B3, may select a third small adjustment value C3 (S23) and may adjust an increase (D>0) or a decrease (D<0) of the gap between the plurality of mill rolls by the adjustment value C3 (S33), when the absolute value of the thickness difference D falls within a third wide section A4~B4, may select a third large adjustment value C4 (S24) and may adjust an increase (D>0) or a decrease (D<0) of the gap between the plurality of mill rolls by the adjustment value C4 (S34), when the absolute value of the thickness difference D falls within a third wide section A5~B5, may select a second large adjustment value C5 (S25) and may adjust an increase (D>0) or a decrease (D<0) of the gap between the plurality of mill rolls by the adjustment value C5 (S35), and when the absolute value of the thickness difference D falls within the widest section A6~B6, may select the largest adjustment value C6 (S26) and may adjust an increase (D>0) or a decrease (D<0) of the gap between the plurality of mill rolls by the adjustment value C6. Depending on a design, the controller 120 (FIG. 2) may increase (D>0) or decrease (D<0) the gap between the plurality of mill rolls by the adjustment value C6 or more even when the absolute value of the thickness difference D does not fall within the widest section A6~B6.

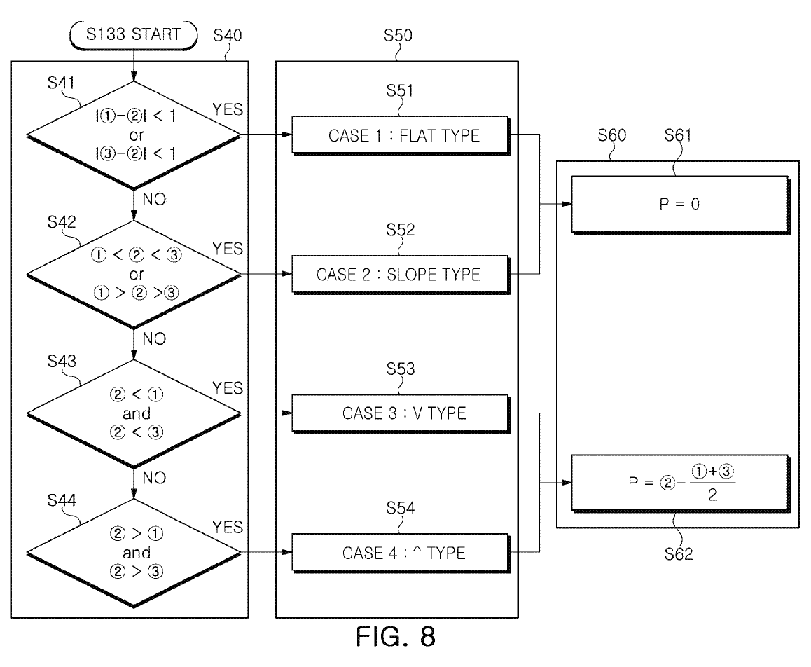

Referring to FIGS. 4 and 8, the second control logic (S133) may determine a magnitude relationship between the central region thickness value (② of FIG. 4), the one-side region thickness value (① of FIG. 4), and the other-side region thickness value (③ of FIG. 4) (S40), select a thickness type of the electrode sheet according to a determination result (S50), and calculate a side pressure control value P of the plurality of mill rolls according to a thickness type of the electrode sheet (S60).

For example, the second control logic (S133) may include determining whether at least one of a second magnitude relationship (|①-②|) or a third magnitude relationship (|③-②|) falls within an error range (e.g., less than 1) including the zero point (S41), and, in a case of such a flat type (S51), maintaining a side pressure of the plurality of mill rolls (S61). An electrode sheet of a flat type may be regarded as an electrode sheet having a sufficiently small thickness deviation.

For example, the second control logic (S133) may include determining whether a positive/negative sign of the second magnitude relationship is different from a positive/negative sign of the third magnitude relationship (①<②<③ or ①>②>③) (S42), and, in a case of such a slope type (S52), maintaining a side pressure of the plurality of mill rolls (S61). In an electrode sheet of a slope type, an average value ((①+③)/2) of the one-side region thickness value (① of FIG. 4) and the other-side region thickness value (③ of FIG. 4) may be similar to the central region thickness value (② of FIG. 4). Since the thickness deviation may be defined as a difference between the average value ((①+③)/2) and the central region thickness value (② of FIG. 4), the electrode sheet of a slope type may also be regarded as an electrode sheet having a sufficiently small thickness deviation.

For example, the second control logic (S133) may include determining whether a positive/negative sign of the second magnitude relationship is equal to a positive/negative sign of the third magnitude relationship (②<① and ②<③) or (②>① and ②>③) (S43, S44), and adjusting a side pressure of the plurality of mill rolls (S53, S54) in such a v-type or a ^-type (S62). Accordingly, the electrode sheet rolled after the v-type or the ^-type electrode sheet is rolled such that the thickness deviation is further reduced.

As described above, a control method and system for a battery electrode roll pressing process, according to an embodiment of the present disclosure, may automatically control various thickness deviations according to various thickness types of the electrode sheet, and thus may stably control the thickness deviation of the electrode sheet even when there is no actual intervention of the operator.

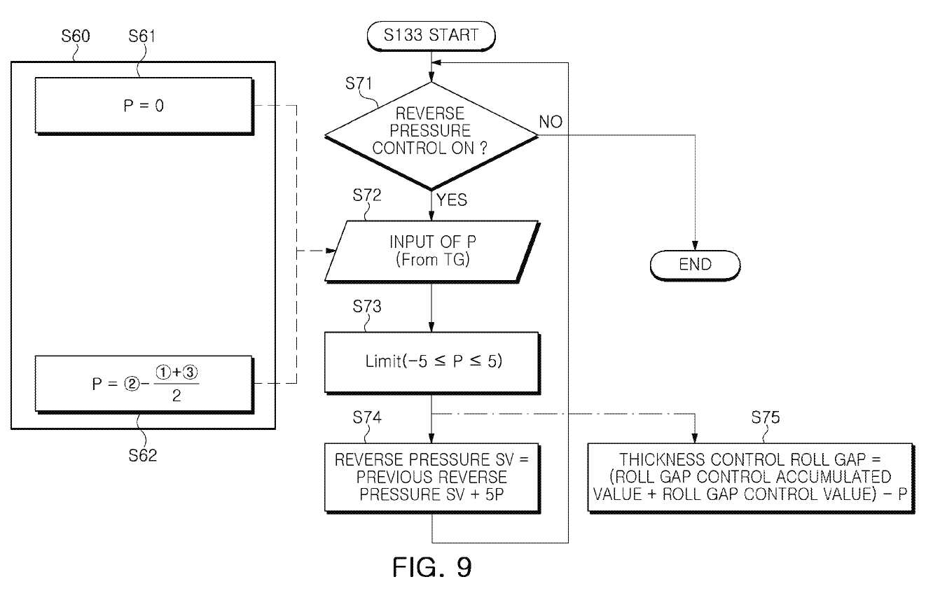

Referring to FIG. 9, a second control logic (S133) may include checking whether a hydraulic cylinder (137 of FIG. 3) uses reverse pressure control (S71), receiving a side pressure control value P according to calculation (S60) (S72), limiting an actual use range (e.g., -5 or more and +5 or less) of the side pressure control value (S73), adjusting a side pressure according to the side pressure control value (S74), and controlling a gap between a plurality of mill rolls (S75) to reduce a change in gap between the plurality of mill rolls according to the adjustment of the side pressure (S74).

Since both side thicknesses of an electrode sheet may also be a portion of an overall thickness of the electrode sheet, control of the side pressure of the electrode sheet may also affect the overall thickness of the electrode sheet. For example, when the side pressure of the electrode sheet increases (or decreases) a one-side region thickness value (① of FIG. 4) and an other-side region thickness value (③ of FIG. 4) may decrease (or increase) and a central region thickness value (② of FIG. 4) may be substantially maintained, but an average value ((①+②+③)/3) of the thickness values may also be slightly reduced (or increased). In this case, the control (S75) of the second control logic (S133) may control (S75) to slightly increase (or decrease) the gap between the plurality of mill rolls, as the average value ((①+②+③)/3) of the thickness values slightly decreases (or increases).

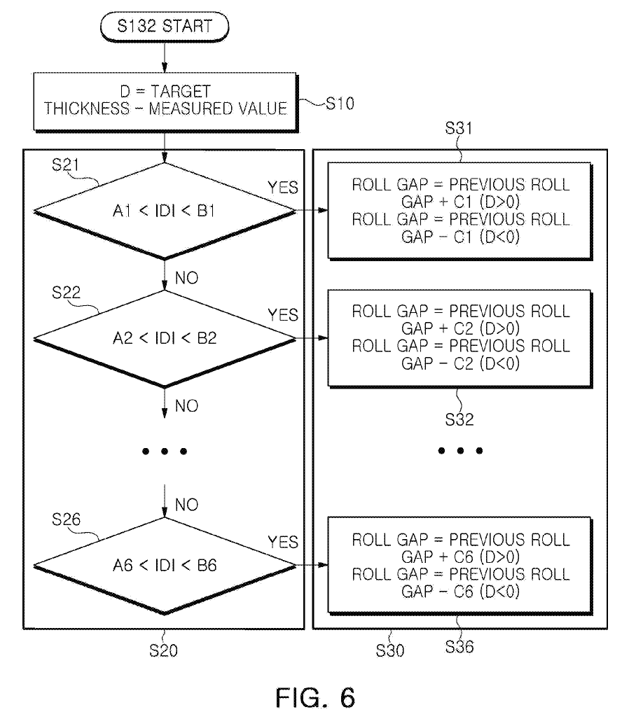

For example, the controlling (S133) may include generating a first adjustment value (e.g., an adjustment value selected in S30 of FIG. 6) and a second adjustment value (e.g., an adjustment value according to S75 of FIG. 9) reducing a change in gap between the plurality of mill rolls due to the adjustment of the side pressure, and adjusting the gap between the plurality of mill rolls, based on a summed adjustment value of the first adjustment value and the second adjustment value.

Accordingly, it is possible to prevent the controller (120 in FIG. 2) from performing roll gap control for a unit time too large. As the number of roll gap control times decreases during a unit time, control complexity of the controller (120 in FIG. 2) may be alleviated, and thus control stability and/or speed may be further increased.

A control method and system for a battery electrode roll pressing process, according to an embodiment of the present disclosure, may control an overall thickness and a thickness deviation of an electrode sheet rolled according to a roll pressing process, and may be advantageous to establish automated thickness control of the electrode sheet.

For example, according to an embodiment of the present disclosure, an overall thickness and a thickness deviation of an electrode sheet may be stably controlled for a long period of time, need for manual control intervention of an operator may be reduced, and overall thickness control of the electrode sheet may be more stably automated.

For example, according to an example of the present disclosure, thickness deviation at each point of an electrode sheet may be stably reduced, and quality (e.g., defect prevention) of a battery electrode manufactured from the electrode sheet may be improved. For example, some of battery defect factors may be due to thickness deviation of an electrode sheet, but according to an example of the present disclosure, since the thickness deviation may be reduced after the electrode sheet is rolled, a battery defect factor due to the thickness deviation of the battery electrode may be removed, and a battery defect rate may be reduced.

Only specific examples of implementations of certain embodiments may be described. Variations, improvements and enhancements of the disclosed embodiments and other embodiments may be made based on the disclosure of this patent document.

What is claimed is:

1. A control method for a battery electrode roll pressing process, comprising:
obtaining a central region thickness value, a one-side region thickness value, and an other-side region thickness value for an electrode sheet rolled by a plurality of mill rolls; and
controlling a gap between the plurality of mill rolls and a side pressure of the plurality of mill rolls, based on the central region thickness value, the one-side region thickness value, and the other-side region thickness value,
wherein the controlling uses a first control logic controlling the gap between the plurality of mill rolls, based on a first magnitude relationship of at least one of the central region thickness value, the one-side region thickness value, or the other-side region thickness value, with respect to a target thickness value, and
uses a second control logic selectively adjusting the side pressure of the plurality of mill rolls, according to whether a positive/negative sign of a second magnitude relationship of the one-side region thickness value with respect to the central region thickness value is equal to a positive/negative sign of a third magnitude relationship of the other-side region thickness value with respect to the central region thickness value.

2. The control method of claim 1, wherein the second control logic includes:
adjusting the side pressure of the plurality of mill rolls, when the positive/negative sign of the second magnitude relationship is equal to the positive/negative sign of the third magnitude relationship, and
maintaining the side pressure of the plurality of mill rolls, when the positive/negative sign of the second magnitude relationship is different from the positive/negative sign of the third magnitude relationship, a slope type.

3. The control method of claim 2, wherein the second control logic includes maintaining the side pressure of the plurality of mill rolls, when at least one of the second magnitude relationship or the third magnitude relationship falls within an error range including a zero point, a flat type.

4. The control method of claim 1, wherein the second control logic includes controlling the gap between the plurality of mill rolls to reduce a change in the gap between the plurality of mill rolls according to the controlling the side pressure.

5. The control method of claim 4, wherein the controlling includes generating a first adjustment value based on a thickness difference between at least one of the central region thickness value, the one-side region thickness value, or the other-side region thickness value, and a target thickness value, and a second adjustment value reducing the change in the gap between the plurality of mill rolls according to the adjustment of the side pressure, and adjusting the gap between the plurality of mill rolls, based on a summed adjustment value of the first and second adjustment values.

6. The control method of claim 1, wherein the first control logic includes selecting, according to whether a thickness difference between at least one of the central region thickness value, the one-side region thickness value, or the other-side region thickness value, and a target thickness value falls within a plurality of sections, one of a plurality of adjustment values corresponding to each of the plurality of sections, and adjusting the gap between the plurality of mill rolls by a first adjustment value selected from the plurality of adjustment values.

7. The control method of claim 1, wherein the first magnitude relationship is a magnitude relationship with respect to the target thickness value, of an averaged value of at least two of the central region thickness value, the one-side region thickness value, or the other-side region thickness value.

8. The control method of claim 1, wherein the plurality of mill rolls are configured to roll the electrode sheet, as the electrode sheet passes between the plurality of mill rolls, and
a direction in which one-side region and the other-side region of the electrode sheet face each other is perpendicular to a passage direction in which the electrode sheet passes between the plurality of mill rolls.

9. The control method of claim 1, wherein the controlling includes adjusting pressures of hydraulic cylinders on one side and the other side of the plurality of mill rolls, to adjust the side pressure.

10. A system for a battery electrode roll pressing process, comprising:
a plurality of mill rolls rolling an electrode sheet;
a thickness measuring instrument measuring a central region thickness value, a one-side region thickness value, and an other-side region thickness value for an electrode sheet; and
a controller controlling a gap between the plurality of mill rolls and a side pressure of the plurality of mill rolls, based on the central region thickness value, the one-side region thickness value, and the other-side region thickness value,
wherein the controller uses a first control logic controlling the gap between the plurality of mill rolls, based on a first magnitude relationship of at least one of the central region thickness value, the one-side region thickness value, or the other-side region thickness value, with respect to a target thickness value, and
uses a second control logic selectively adjusting the side pressure of the plurality of mill rolls, according to whether a positive/negative sign of a second magnitude relationship of the one-side region thickness value with respect to the central region thickness value is equal to a positive/negative sign of a third magnitude relationship of the other-side region thickness value with respect to the central region thickness value.

11. The system of claim 10, wherein the second control logic includes controlling the gap between the plurality of mill rolls to reduce a change in the gap between the plurality of mill rolls according to the controlling the side pressure.

12. The system of claim 11, wherein the controller generates a first adjustment value based on a thickness difference between at least one of the central region thickness value, the one-side region thickness value, or the other-side region thickness value, and a target thickness value, and a second adjustment value reducing the change in the gap between the plurality of mill rolls according to the adjustment of the side pressure, and adjusts the gap between the plurality of mill rolls, based on a summed adjustment value of the first and second adjustment values.

13. The system of claim 12, wherein the first control logic includes selecting, according to whether a thickness difference between at least one of the central region thickness value, the one-side region thickness value, or the other-side region thickness value, and a target thickness value falls within a plurality of sections, one of a plurality of adjustment values corresponding to each of the plurality of sections, and adjusting the gap between the plurality of mill rolls by the first adjustment value selected from the plurality of adjustment values.

14. The system of claim 10, wherein the second control logic includes:
adjusting the side pressure of the plurality of mill rolls, when the positive/negative sign of the second magnitude relationship is equal to the positive/negative sign of the third magnitude relationship, and
maintaining the side pressure of the plurality of mill rolls, when the positive/negative sign of the second magnitude relationship is different from the positive/negative sign of the third magnitude relationship, a slope type.

15. The system of claim 10, wherein the second control logic includes maintaining the side pressure of the plurality of mill rolls, when at least one of the second magnitude relationship or the third magnitude relationship falls within an error range including a zero point, a flat type.
